(19) United States
(12) Patent Application Publication
(10) Pub. No.: US 2004/0191578 A1
(43) Pub. Date: Sep. 30, 2004

(54) Method of fabricating L10 ordered fePt or FePtX thin film with (001) orientation

(76) Inventors: Jingsheng Chen, Singapore (SG); Yingfan Xu, Lincoln, NE (US); Jian Ping Wang, Minneapolis, MN (US)

Correspondence Address: HOGAN & HARTSON L.L.P., 500 S. GRAND AVENUE, SUITE 1900, LOS ANGELES, CA, 90071-2611, US

(21) Appl. No.: 10/395,827

(22) Filed: Mar. 24, 2003

(51) Int. Cl. G11B 5/70

(52) U.S. Cl. 428/694 TS; 428/694 R

(57) ABSTRACT

Methods are provided for producing L1₀ ordered FePt or FePtX (where X=C, Cr, Zr, Cu, Ta, SiO₂, MgO, Al₂O₃, B₂O₃ or B) thin film with (001) orientation for use in perpendicular magnetic recording media. The methods use strain-induced phase transformation from FCC to FCT. A chromium alloy (CrA) underlayer, where A=Ru, Mo, Mn, W, Ti, Zr or V with (002) preferred orientation is deposited first on any of a variety of disk substrates such as NiP-coated AlMg, glass, glass-ceramic, or glassy carbon. A seed layer such as Ta, NiAl, or C is preferably pre-deposited on the disk substrate. An intermediate layer is deposited on the CrA underlayer to decrease the thickness of an initial growth layer before a FePt or a FePtX film with a (001) texture is deposited on the intermediate layer. These methods produce thin films particularly suitable for recording media with ultrahigh recording densities.

### TECHNICAL FIELD

This invention relates generally to magnetic, recording media for ultrahigh density magnetic recording, and more particularly to a method for in-situ deposition of L1₀ ordered iron platinum thin films with high perpendicular anisotropy.

### BACKGROUND OF THE INVENTION

Magnetic media for data storage have been developed in the form of magnetic disks or magnetic tapes. Magnetic disks come in a number of different forms including floppy disks and hard disks. There is an ever increasing, demand, however, for faster access speeds for stored information and higher data storage densities to lower the cost per bit of information stored. This has propelled the current state of data storage technology to provide storage media with increased storage density. To achieve high recording density a reduction in grain size is required so as to enable more grains per unit area on the magnetic media. The current state of the art in magnetic storage media provides areal density of as high as 100 Gbit/in², where an average grain size is below 10 nm, and has a high coercivity to resist bit demagnetization. However, a further increase in density beyond this latest achievement in areal density will encounter a physical limit. This limit is due to the superparamagnetic effect experienced with further reductions in grain size, which sets in when the grain size becomes so small that thermal energy becomes sufficient to reverse their magnetization spontaneously, leading to the consequent loss of recorded signals.

Another limitation that has been encountered with an increase in areal density is the increase in the coercivity, which requires a suitable write head for storing data. Storing data on such ultra-high density magnetic media requires a high head field. Currently, the use of ring writing heads in longitudinal magnetic recording media of such high areal density is not practical. It has been found, though, that perpendicular magnetic recording media offer several key advantages over longitudinal media. An article, “Perpendicular recording: the promise and the problems”, Journal of Magnetism and Magnetic Materials 235 (2001), pages 1-9, describes that: (a) the higher head field in a pole-head/soft-underlayer configuration allows the use of media with high coercivity and high anisotropy energy density, Kᵤ, which in turn allows for smaller and thermally stable media grains; (b) sharp transitions on relatively thick media can allow more grains per unit area for a given grain volume; (c) strong uniaxial orientation of perpendicular media should lead to a tight switching-field distribution, sharper written transition, and higher signals and lower noise. These properties of the perpendicular media facilitate ultra-high areal density.

Chemically ordered FePt and CoPt with L1ₒ (CuAu—I) structure possess very high magnetic anisotropy energy density, Kᵤ (i.e. Kᵤ˜6−1×10⁷ erg/cm³ for FePt and Kᵤ˜5×10⁷ erg/cm³ for CoPt). This high Kᵤ value allows films of FePt and CoPt to accommodate very small magnetically stable grains, where the grain size for FePt is ˜2.6 nm and that for CoPt is ˜3.6 nm. With the size of the grains in this range, FePt and CoPt thin films become highly advantageous for use as ultra-high areal density recording media.

In known prior art like U.S. Pat. No. 6,139,907, U.S. Pat. No. 6,183,606 and U.S. Pat. No. 6,007,623, chemically ordered L1ₒ FePt or CoPt thin films used for longitudinal media have been synthesized by in-situ sputtering deposition or post-annealing at elevated substrate temperatures. There are certain limitations to the use of longitudinal recording media, however, and it has been discovered that perpendicular magnetic recording media have certain advantages over longitudinal magnetic recording media as set out above. Perpendicular magnetic recording media are thus preferred over longitudinal magnetic recording media.

As disclosed in IEEE Trans. Magn. MAG-36 (1) (2000) 4-9; 36-41 and National Storage Industry Consortium Winter Meeting, Jan. 12-14, 2000, San Diego, perpendicular magnetic recording media have areal densities that are up to 2-8 times higher than those of longitudinal magnetic recording media. To use FePt or CoPt in perpendicular media, the key issue is to obtain (001) orientated L1₀-FePt or CoPt thin films. It has also been reported in “Control of the axis of chemical ordering and magnetic anisotropy in epitaxial films,” J.Appl.Phys. 79, 5967-5969 (1996); “High-anisotropy nanocomposite films for magnetic recording,” IEEE Trans.Magn., 37, 1286-1291(2001); and “Orientation-controlled nonepitaxial L1₀CoPt and FePt films,” Appl.Phys.Lett. 80, 2350 (2002) that (001) orientated L1₀-FePt or CoPt thin films have been successfully synthesized by molecular beam epitaxial growth on MgO single crystalline substrates and by post-annealing the sputtered FePt or CoPt films or FePt—B₂O₃ composite films on a thermally oxidized silicon substrate. However, synthesis of chemically ordered L1₀. FePt and CoPt thin films requires a high post-annealing temperature (higher than 500° C.), or MgO single crystalline substrates, which are not available for the practical industrial applications due to their high cost.

“Preparation of ordered FePt thin films for perpendicular magnetic recording media,” J.Magn.Magn.Mater. 193, 85 (1999), reports that (001) oriented FePt films were obtained on a Cr(002)/MgO/glass substrate at a temperature below 500° C. with high pressure sputtering. Analysis of the films suggested that compressive stress from the high sputtering pressure aided the change of the FePt from its fcc phase to its fct phase with a reduction in the formation temperature.

The present invention provides alternative methods for synthesizing (001) oriented L1ₒ FePt thin films for perpendicular media at relatively low temperatures (below 500° C.).

### SUMMARY OF THE INVENTION

The present invention is embodied in methods to deposit (001) oriented L1ₒ FePt, or L1₀ FePtX films (where X=C, Cr, Zr, Cu, Ta, SiO₂, MgO, Al₂O₃, B₂O₃ or B), in situ by DC or RF magnetron sputtering at relative low substrate temperatures (below 500° C.) for use in perpendicular recording media. These embodiments utilize epitaxial growth and phase transformation from FePt-fcc to FePt-fct with the aid of strain energy arising from lattice misfits. The invention provides methods for fabricating magnetic films on substrates, which include depositing an underlayer on the substrate and a magnetic layer by using a magnetron sputtering system. The underlayer is formed by depositing a chromium alloy (CrA, where A is selected from various suitable alloying materials) with the chromium alloy having a (002) orientation while the magnetic layer is formed by depositing an iron platinum alloy of a face-centered-tetragonal (fct) structure with a (001) orientation.

The chromium alloy is selected from a group of alloys consisting of chromium ruthenium (CrRu), chromium molybdenum (CrMo), chromium manganese (CrMn), chromium tungsten (CrW), chromium titanium (CrTi), chromium zirconium (CrZr), and chromium vanadium (CrV), which is to change the lattice constant and to adjust the misfit between the FePt and the underlayer and thus the strain energy at the interface between them. The percentage of chromium in the alloys preferably ranges from 80% to 100%. More preferably, the percentage ranges from 90% to 94%, with a film thickness that ranges from 5 nm to 80 nm. During depositing of the underlayer, the substrate is maintained at a temperature range from about 200° C. to about 400° C.

Some preferred embodiments include an intermediate layer deposited on the chromium alloy (CrA) underlayer, with the magnetic layer deposited onto the intermediate layer. The intermediate layer decreases the thickness of the initial layer in the magnetic layer while maintaining the strain that arises due to the misfit between the underlayer and the magnetic layer, and which is exerted on the magnetic layer. Preferably, the intermediate layer has a thickness in the range from about 1 nm to about 4 nm and has a lattice constant and structure that matches the lattice constant and structure of the underlayer, the magnetic layer, or both. An example of such an intermediate layer is that formed by depositing a nickel aluminum (NiAl) or iron aluminum (FeAl) alloy of B2 structure and which match the lattice constant and structure of the underlayer. Another example is face-centered-cubic (fcc) structure platinum (Pt) or palladium (Pd), which matches the lattice constant and structure of the (FePt) magnetic layer. The intermediate layer can also have a lattice constant that matches that of the underlayer, the magnetic layer, or both. An alternative embodiment of the present invention has an intermediate layer with a structure that matches that of the underlayer, the magnetic layer, or both. An example of such an intermediate layer is the face centered cubic structure of elements like silver (Ag), gold (Au), and aluminum (Al), which matches the lattice constant of the chromium alloy (CrA) underlayer and the structure of the FePt magnetic layer. Another alternative is the body-centered-cubic structure element of Fe, which matches the lattice constant of the FePt magnetic layer.

The magnetic layer is formed by (i) magnetron co-sputtering of iron (Fe) and platinum (Pt) or (ii) magnetron sputtering of iron platinum (FePt) alloy to form an iron platinum (FePt) thin film. Alternatively, the magnetic layer may be formed by (iii) co-sputtering of iron (Fe) and platinum (Pt) or (iv) sputtering of iron platinum (FePt) alloy in the presence of any one of the elements in the group X (where X=carbon (C), chromium (Cr), zirconium (Zr), copper (Cu), tantalum (Ta), boron (B), silicon oxide (SiO₂), magnesium oxide (MgO), boron oxide (B₂O₃), or aluminum oxide (Al₂O₃)) to form a doped iron platinum (FePtX) thin film. The temperature of the sputtering or co-sputtering is maintained at below 500° C. and the thickness of the magnetic layer ranges from about 5 nm to about 20 nm.

The substrate in the present invention is preferably Ni—P coated AlMg, glass, glass ceramic, or glassy carbon pre-coated with a seed layer to decrease the grain size in the underlayer and magnetic layer, The seed layer is preferably tantalum (Ta), nickel aluminum (NiAl), or carbon (C).

Another aspect of the present invention provides a magnetic recording medium with a film having a layered structure on a disk substrate produced by the above method.

### BRIEF DESCRIPTION OF THE DRAWINGS

The details of the present invention will become apparent by reference to the following description and accompanying drawings wherein:

FIG. 1a is a schematic diagram of the superlattice of FePt intermetallic alloy.

FIG. 1b is a schematic diagram illustrating epitaxial growth of FePt(001)[100]//CrA(002)[110].

FIG. 1c is a schematic diagram illustrating strain-induced phase transformation from FePt-fcc to FePt-fct.

FIG. 2 is a schematic sectional view of the structure of a perpendicular recording medium according to a preferred embodiment of the invention.

FIG. 3 is a graph depicting θ-2θ XRD spectra of Cr₁₀₀₋ₓRuₓ/FePt films with x varying from 0 to 11.6.

FIG. 4 is a graph depicting the variation of the out-of-plane and in-plane coercivities with the Ru content in the Cr underlayer and the change of the corresponding lattice misfit between the CrRu underlayer and the FePt films.

FIG. 5 is a graph depicting θ-2θ XRD spectra of Cr₉₁Ru₉/FePt films with various substrate temperatures.

FIG. 6 is a graph depicting the variation of the out-of-plane and in-plane coercivities with substrate temperature.

FIG. 7 is a schematic sectional view of the structure of a perpendicular recording medium according to another preferred embodiment of the present invention.

FIG. 8 is a graph depicting θ-2θ XRD spectra of Cr₉₁Ru₉/Pt/FePt films with various thickness of the Pt intermediate layer.

FIG. 9 is a graph depicting dependence of the long-range-ordering parameter (S) on the intermediate layer thickness.

FIG. 10 is a graph depicting the variation of the out-of-plane and in-plane coercivities with various Pt intermediate layer thicknesses.

FIG. 11 is a graph depicting θ-2θ XRD spectra of Cr₉₁Ru₉/Pt/FePt films with 4 nm Pt intermediate layer at various deposition temperatures.

FIG. 12 is a graph depicting the dependence of the out-of-plane and in-plane coercivities of Cr₉₁Ru₉/Pt/FePt film on the thickenss of the Pt intermediate layer.

FIG. 13 is a graph depicting the out-of-plane and in-plane hysteresis loops of Cr₉₁Ru₉ (80 nm)/Pt (4 nm)/FePt (20 nm) deposited at 400° C.

### DETAILED DESCRIPTION OF THE INVENTION

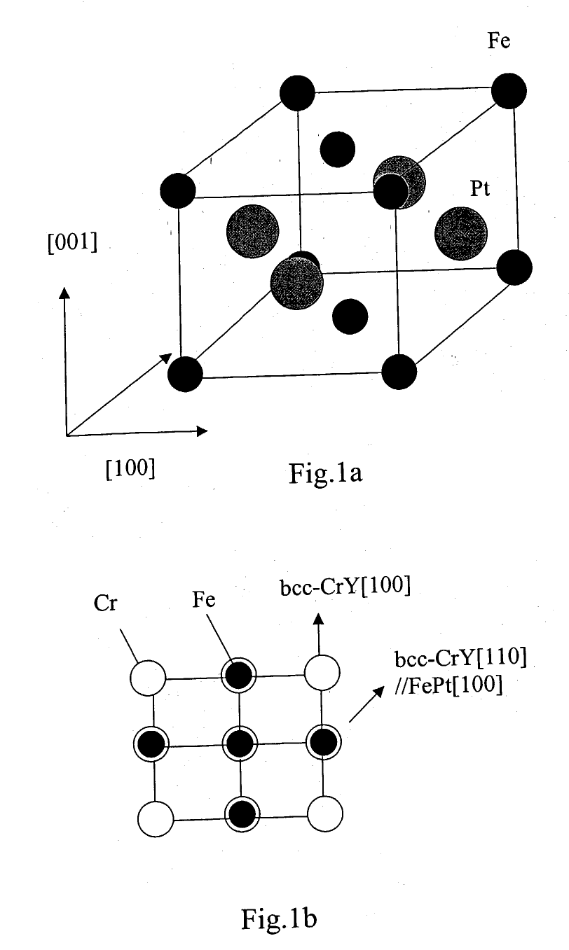

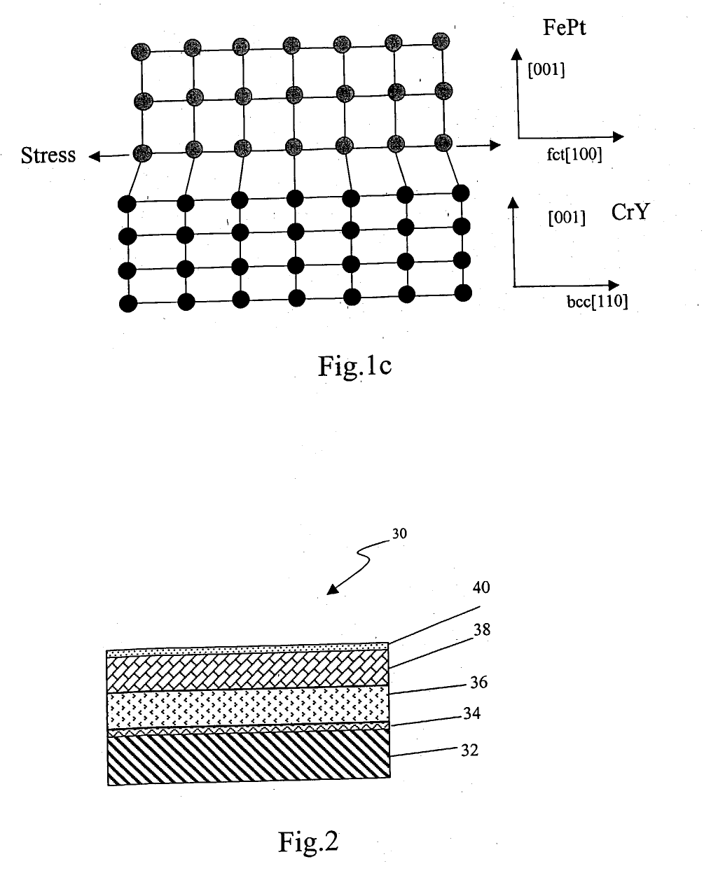

Preferred embodiments of the invention include in-situ deposition of (001) oriented L1₀ FePt or L1₀ FePtX films (where X=C, Cr, Zr, Cu, Ta, SiO₂, MgO, Al₂O₃, (B₂O₃) or B) by DC or RF magnetron sputtering at relatively low substrate temperatures (below 500° C.) as compared to prior art conditions for use in perpendicular recording media. These embodiments make use of epitaxial growth and phase transformation from FePt-fcc to FePt-fct with the aid of strain energy arising from the lattice misfits. The basic principle of the present invention is illustrated in FIGS. 1a-1c.

FIG. 1a shows the crystal structure of the face-centered tetragonal (L1₀) FePt intermetallic superlattice where the atomic layers of iron (Fe) and platinum (Pt) alternate along the [001] direction and the lattice constant a is slightly larger than the lattice constant c. A chromium alloy (CrA, where A is a suitable alloying element) underlayer of BCC structure with a (002) orientation in the film plane was deposited onto the substrate before the magnetic layer of FePt or FePtX. This underlayer, which has an in-plane atomic coordination similar to FePt (001), helps to control the orientation of the FePt grains. The crystallographic relationship of the chromium alloy underlayer and the iron platinum alloy magnetic layer, CrA(002)[110]//FePt(001)[100], is illustrated in FIG. 1b. Since the lattice of the chromium underlayer and the iron platinum alloy magnetic layer do not match exactly within the same plane, there is a lattice misfit of the Cr(002)/FePt(001) planes of about 5.8%, which suggests that tensile stress along the FePt a-axis induces expansion along the a-axis and contraction along the c-axis, thereby promoting the formation of the fct structure, as shown in FIG. 1c. It is found that by incorporating other elements (A) such as Ru, Mo, W, Ti, V, Zr, etc., in the Cr underlayer to form chromium alloy (CrA) as part of the underlayer, the orientation of the Cr (002) can be further controlled which also leads to a simultaneous change in the lattice misfit. The strain energy also changes due to the presence of such elements in the underlayer. It is believed that such changes enable the strain-induced fct phase to form, which lowers the ordering temperature of the FePt.

In a preferred embodiment of the present invention 30 as shown in FIG. 2, an underlayer 36 of chromium alloy (CrA, where A=Ru, Mo, Mn, W, Ti, V, Zr, etc.) is deposited by DC or RF magnetron sputtering onto any of a variety of disk substrates 32, with a seed layer 34 formed before the underlayer 36. A magnetic layer 38 is then deposited on the underlayer 36 followed by an overcoating 40 to protect the magnetic layer. Suitable disk substrates include NiP-coated AlMg, glass, glass-ceramic, glassy carbon, etc., and the seed layer includes Ta, C, or NiAl, which has the effect of decreasing the crystal size of the chromium alloy (CrA) underlayer 36 and hence the crystal size of iron platinum alloy (FePt or FePtX) magnetic films 38. The deposition temperature of the CrA underlayer 36 range from 150° C. to 400° C. and is preferably in the range of 200° C.-300° C. The chromium alloy (CrA) underlayer 36 has a percentage composition of the element Y such as Ru, Mo, W, Ti, V, Zr, etc. in the range of about 0% to 20% by atomic ratio, more preferably about 6% to 10%. The FePt or FePtX magnetic films 38 with grains in the (001) orientation can be deposited onto the CrA underlayer 36, with Cr (002) orientation, at a relatively low substrate temperature (below 500° C.) by RF or DC magnetron sputtering. The following example is a discussion of the performance of such a magnetic medium where A is ruthenium (Ru):

### EXAMPLE 1

The magnetic medium has the structure: Glass/Cr₁₀₀₋ₓRuₓ/FePt deposited by DC magnetron sputtering where the chemical composition of the magnetic layer is about Fe₅₀Pt₅₀ with deviation of about 1% by atomic ratio. The thickness of the magnetic layer is about 20 nm while the underlayer has a thickness of about 80 nm. The glass substrate was heated and held at the set-point temperature of 400° C. for 10 minutes before sputtering.

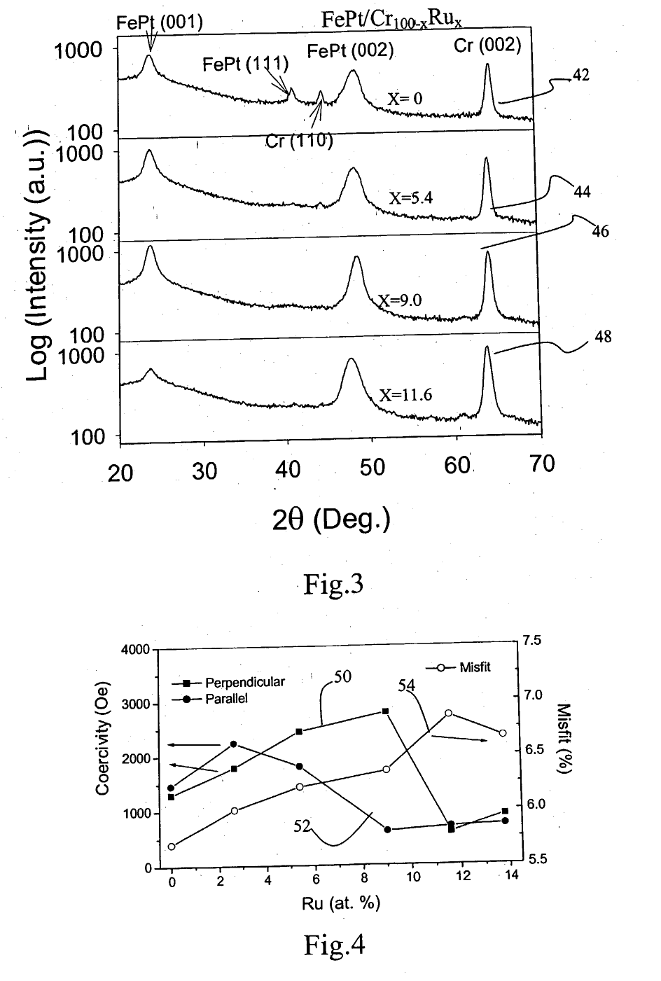

The X-ray diffraction scan (XRD) spectra 42, 44, 46, and 48 in FIG. 3 depict the effect of the Ru content on the crystallographic structure of the CrRu underlayer and the FePt magnetic layer, where the set-point temperature is set at 400° C. and x=0%, 5.4%, 9.0% and 11.6%. With the increase of the Ru content, the Cr (002) peaks shifted to a lower angle, indicating an increase in Cr lattice constant which also indicates that a change in the lattice misfit between the CrRu underlayer and the FePt layer has taken place. It is observed from the spectrum 42 of the sample with no Ru in the Cr underlayer, x=0%, that the FePt (111) peak and Cr (110) peak have weak intensities. With the addition of some Ru in Cr underlayer, x=5.4%, however, these weak peaks of Cr (110) and FePt (111) disappear as seen in the spectrum 44. The FePt fct-(001) texture becomes more prominent as seen in the spectrum 46, where the intensity of the FePt (001) peak increases with the Ru content increased up to x=9.0% by atomic ratio. The increase of the Cr lattice constant with the Ru content in the Cr underlayer increases the lattice mismatch between the Cr(002) plane and the FePt (001) plane. This may increase the strain between the FePt (001)[100] and the Cr(002)[110], which is thought to enhance the strain-induced fct phase formation. It is further observed that increasing the Ru content in the Cr underlayer beyond x=9% results in a dramatic drop of the FePt (001) peak intensity. As shown in the spectrum 48, increasing the Ru content up to 11.6% by atomic ratio (at. %) in the Cr underlayer enlarges the Cr lattice constant further. This may start to induce more dislocations or stacking faults at the interface between the CrRu underlayer and the FePt magnetic layer, which may cause relaxation of the expected strain. The strain relaxation between the CrRu layer and the FePt layer may result in the formation of less fct FePt phase with some amount of fcc FePt phase. Further study of the coercivities and misfit lattice between the CrRu underlayer and the FePt or FePtX magnetic film re-enforces this phenomenon. FIG. 4 illustrates the variation of the out-of-plane and in-plane coercivities of Cr₁₀₀₋ₓRuₓ (80 nm)/FePt (20 nm), and the change of the lattice misfit between the CrRu underlayer and the FePt films with the increase in ruthenium (Ru) content in the Cr underlayer in the plots 50, 52, and 54, respectively. From the plot 50, the out-of-plane coercivity increases linearly with the Ru content and reaches its maximum at 9.0 at. % Ru, then decreases dramatically as the Ru content in the Cr underlayer further increases, reaching a minimum at the Ru content of ˜11.6 at. %. From the plot 52, the in-plane coercivity is shown to increase first and then decrease, reaching a minimum value at 9.0 at. % Ru. Further increase in the Ru content shows a very gradual increase in the in-plane coercivity. In the plot 54, the increase of the Ru content in the Cr underlayer shows the lattice misfit increasing gradually, then between the further increase of 9% to ˜11.6% of Ru content by atomic ratio, a sharp increase in lattice misfit is observed, where the maximum occurs with Ru content at 11.6 at. %. Beyond this percentage of Ru content in the underlayer, the lattice misfit decreases. These results indicate that with adequate lattice mismatch between the FePt (001) plane and the Cr (002) plane, the ordering of FePt with fct (001) preferred orientation during in situ deposition can be realized. The ordered FePt (001) plane is epitaxially grown on the CrRu (002) plane during deposition. The FePt [010] and [100] axes may be expanded along the CrRu [110] axis under a strain that arises from the lattice misfit between CrRu and FePt. The lattice misfit between the CrRu and the FePt layers varies according to changes in the percentage content of Ru from 0 to 9.0% by atomic ratio, from about 5.8%-6.8%. This expansion may cause expansion of the a-axis (FePt [100]) and shrinkage of the c-axis (FePt [001]). Comparatively, the ordered FePt film will have a c-axis smaller than its a-axis. The ratio of c/a of FePt film with 9.0 at. % Ru in the Cr underlayer is about 0.975. This distortion of the FePt unit cell may result in the formation of ordered FePt grains with an easy axis perpendicular to the film plane, i.e., the FePt (001) texture. However, too large a lattice mismatch may induce a high density of defects at the interface between the FePt and the Cr layers, which will hinder the FePt (001) plane's epitaxial growth well and cause a corresponding decline in the material's magnetic property. This is evident in the results shown in the plots 50, 52, and 54, where beyond the Ru content of 9 at. %, the misfit decreases and the out-of-plane coercivity decreases drastically.

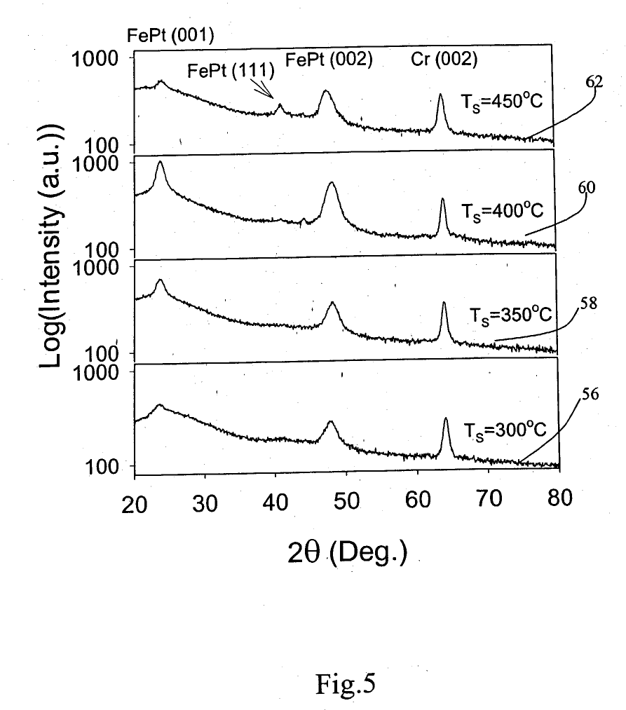

FIG. 5 shows θ-2θ XRD spectra 56, 58, 60, and 62 of Cr₉₁Ru₉ (80 nm)/FePt (20 nm) films at respective substrate temperatures of 300° C., 350° C., 400° C. and 450° C. At the substrate temperature of 300° C., weak FePt-fct (001) intensity was observed in the spectrum 56, indicating that the FePt film is less chemically ordered. Increasing the substrate temperature to 350° C., the superlattice peak (001) of L1₀ FePt appears in the spectrum 58. As the substrate temperature is increased to 400° C., the intensity of the L1₀ FePt (001) peak increases and becomes more prominent as shown in the spectrum 60. With a further increase of the substrate temperature beyond 400° C. to 450° C., the intensity of the L1₀ FePt (001) diminishes to a negligible peak as observed from the spectrum 62. These results suggest that with the help of strain energy between the underlayer CrA and magnetic layer FePt, the FePt magnetic film begin to order at 350° C. When the substrate temperature is above 450° C., the disappearance of L1₀ FePt (001) peak can be ascribed to an increase in the thickness of the initial growth layer in the FePt magnetic layer.

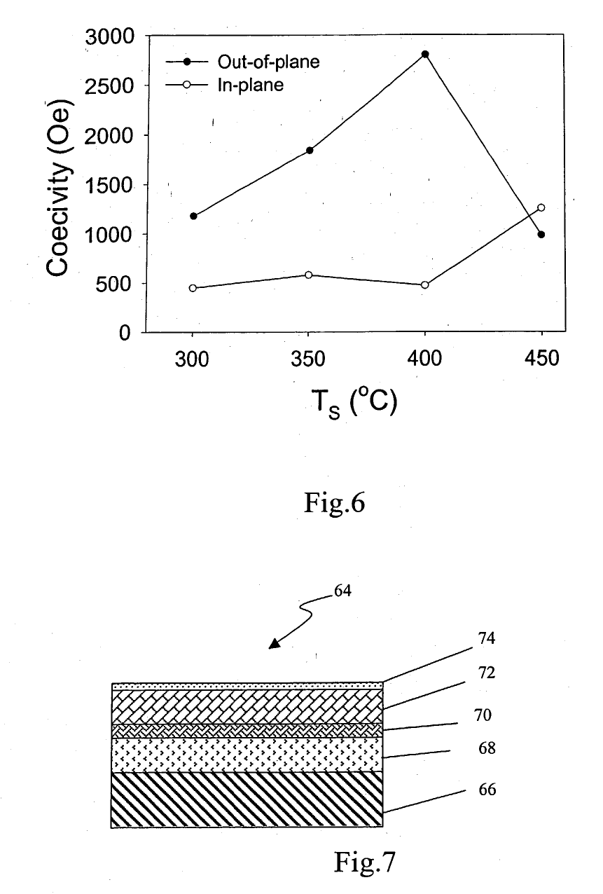

FIG. 6 shows the variation of the out-of-plane and in-plane coercivities of Cr₉₁Ru₉ (80 nm)/FePt (20 nm) films with substrate temperature. It is also shown that the out-of-plane coercivity increases with increasing substrate temperature, reaching a maximum at 400° C. and then dropping drastically as the substrate temperature increases further. These results are consistent with the X-ray diffraction scan (XRD) results shown in FIG. 5.

FIG. 7 illustrates another embodiment of the invention in which the perpendicular recording medium 64 includes a disk substrate 66 with a chromium alloy (CrA) underlayer 68 deposited on it. An intermediate layer 70 is deposited onto the CrA underlayer 68, from which the iron platinum alloy (FePt or FePtX) magnetic film 72 with good (001) orientation can be epitaxially grown. An overcoat 74 is added as protective layer over the magnetic layer 72. The intermediate layer 70 has a lattice constant that matches either the underlayer or FePt magnetic layer. This intermediate layer 70 serves to decrease the initial growth layer of the magnetic layer 72 while maintaining the strain exerted on the magnetic layer. The intermediate layer 70 is preferably a B2 structure such as NiAl or FeAl, which well matches both the lattice constant and the structure of the underlayer, or a face centered cubic (FCC) structure such as Au, Ag, Al, etc., which matches the lattice constant of the underlayer 68 and the structure of the (FePt) magnetic layer 72. A face-centered cubic (FCC) structure such as Pt, Pd, etc. that matches both the lattice constant and the structure of the above FePt magnetic layer, or a body-centered cubic (BCC) structure such as that of Fe which matches the lattice constant of the FePt magnetic layer, is also suitable for use as the intermediate layer 70. The following example discusses the results of studies conducted on such a magnetic medium 64 with platinum (Pt) as the intermediate layer 70.

### EXAMPLE 2

Samples of a magnetic recording medium with the structure: Glass/Cr₁₀₀₋ₓRuₓ/Pt/FePt deposited on glass substrates by DC magnetron sputtering, where the thickness of the magnetic layer is 20 nm and that of the underlayer is 80 nm, were prepared for analysis. The chemical composition of the magnetic layer 72 is about Fe₅₀Pt₅₀ with deviation of 1 at. %. The glass substrate 66 was heated and held at the set-point temperature for 10 minutes before sputtering. The platinum (Pt) intermediate layer 70 varies in thickness, t_{Pt}=0, 1, 4, 6 nm, and properties influenced by the thickness are studied.

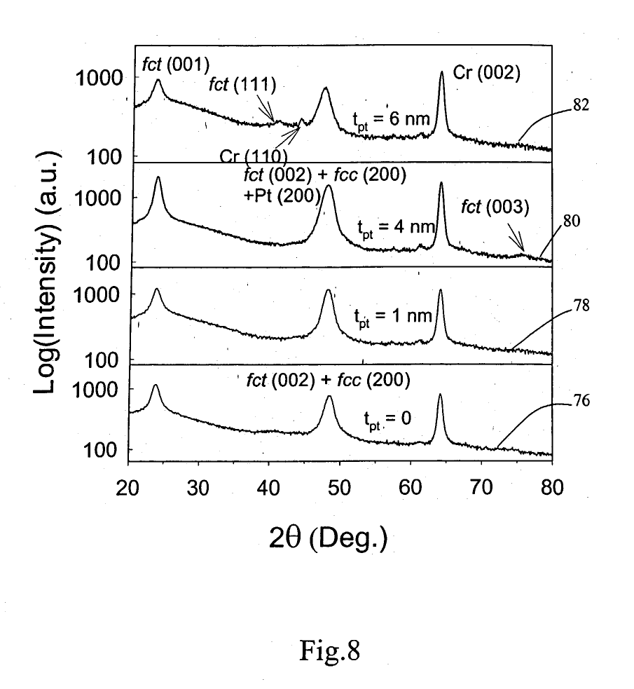

FIG. 8 shows the X-ray diffraction scan (XRD) spectra of Cr₉₁Ru₉ (80 nm)/Pt/FePt (20 nm) with various thicknesses, t, of the Pt intermediate layer deposited at a substrate temperature of 400° C. For all of the samples with different thicknesses, t_{Pt}, the FePt-fct (001) peak was observed in the XRD spectra 76, 78, 80 and 82, which indicates that the L1₀ ordered FePt films with (001) preferred orientation are achieved. After introducing a Pt intermediate layer at a thickness, t_{Pt}=1 nm, there is no obvious change in the XRD spectra 78. For the sample with the Pt intermediate layer thickness, t_{Pt}=4 nm, the intensity of the FePt-fct (001) peak increases and a small and broad FePt-fct (003) was also observed in the spectrum 80. This indicates a better FePt-fct (001) texture. In the spectrum 82, further increasing the Pt intermediate layer thickness, t_{Pt}=6 nm, the intensity of the FePt-fct (001) peak decreases and FePt (111) and Cr (110) peaks were also observed. Moreover, the FePt-fct (001) peak and the peak between 45° and 50° shift to lower angles when the Pt intermediate thickness, t, increases from 0 nm to 6 nm. The shift of the FePt (001) peaks suggests that the lattice constant c increases. The shift of the peaks between 45° and 50° may be ascribed to: (i) the enhancement and shift of the Pt (002) peak; (ii) the shift of the FePt-fct (002) peak; and (iii) the increase of the FePt-fec (200) or other L1₀ variants with [001] direction in the plane such as FePt-fct (200). In addition, the shift of the Pt (002) peak, which usually occurs at 46.28°, to a larger angle indicates that the Pt crystalline cell is distorted such that it is expanded along the a-axis in the film plane and contracted along the c-axis normal to the film plane. This may be due to the strain from lattice misfit between the Pt intermediate layer and the CrRu underlayer. This also suggests that FePt-fct phase formation is favored by strain from the underlayer, expanding the FePt[100]-axis and shrinking the FePt [001]-axis. The shift of the Pt (002) peak to a lower angle with the increase of the Pt intermediate layer thickness suggests that the strain arising from the misfit between the Pt and CrRu underlayer is gradually released.

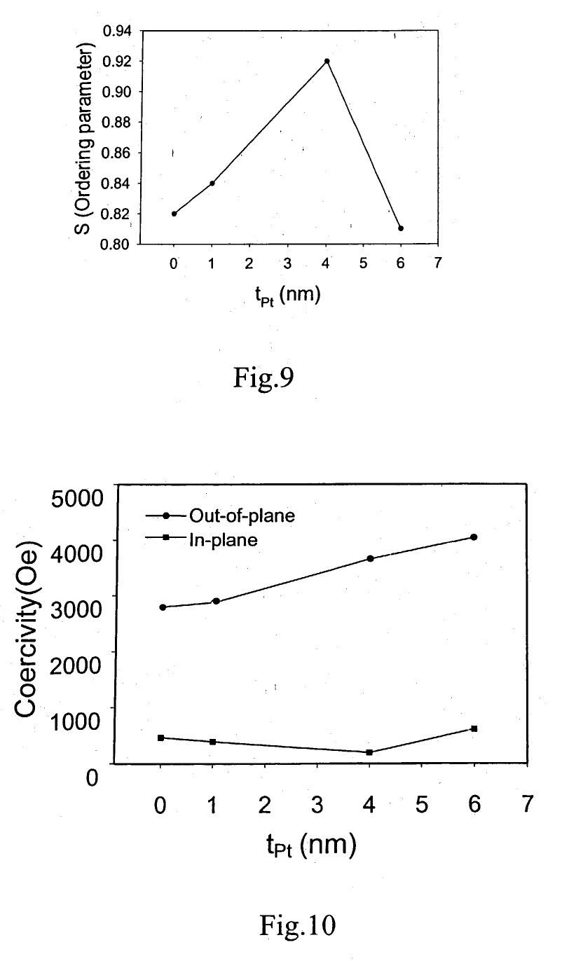

FIG. 9 shows the dependence of the long-range-ordering parameter, S, on the intermediate layer thickness. In an ideal scenario where the magnetic film is completely chemically ordered, the long-range-ordering parameter S=1. A value of S close to 1 indicates that the magnetic film is more chemically ordered. It is found that S increases with the increase in thickness of the Pt intermediate layer. When the thickness of the Pt intermediate layer t_{Pt}=4 nm, S reaches its maximum. A further increase of the Pt intermediate layer thickness, t_{Pt}, results in a decrease in S.

From the results in FIG. 8 and FIG. 9, the increase in the FePt-fct (001) preferred orientation and the increase in the ordering to fct-structure can be interpreted as the combined effect of Cr diffusion from the underlayer and the strain energy between the CrA underlayer and the magnetic layer. The improvement of the fct (001) orientation and the ordering of FePt film at Pt intermediate layer thickness t_{Pt}=4 nm can be attributed to the suppression of the Cr diffusion. When the thickness of the Pt intermediate layer increases to t_{Pt}=6 nm, the Cr diffusion which blocks the strain energy aiding the transformation from the FePt-fcc phase into the FePt-fct phase is released and thus causes a shift of the ordering of the FePt-fct film to its FePt-fcc phase.

FIG. 10 shows the variation of the out-of-plane and in-plane coercivities of Cr₉₁Ru₉ (80 nm)/Pt/FePt (20 nm) with the thickness, t_{Pt}, of the Pt intermediate layer. The out-of-plane coercivity of the films increases with increasing thickness of the Pt intermediate layer. For the FePt films with no intermediate layer, t_{Pt}=0 nm, serious Cr diffusion may have resulted in more defects in the FePt-fct grains that help to pin the domain wall. In addition, the Cr diffusion would deteriorate the ordering of FePt grains and degrade the magnetic anisotropy of the films and thus decreasing the coercivity. This can be altered by adding the Pt intermediate layer df thickness t_{Pt}=4 nm to block the Cr diffusion. By further increasing the thickness of the Pt intermediate layer, Cr diffusion is prevented, which relaxes the strain energy between the CrA underlayer and the FePt (or FePtX) magnetic layer allowing the order of the iron platinum film to shift from its FePt-fct phase to its FePt-fcc phase. When the thickness, t_{Pt}, of the intermediate Pt layer is further increased beyond t_{Pt}=4 nm, the coercivity increases. This is due to the FePt-fcc/fct boundaries and variants boundaries of FePt-fct (001) acting as the pinning sites of the domain wall motion.

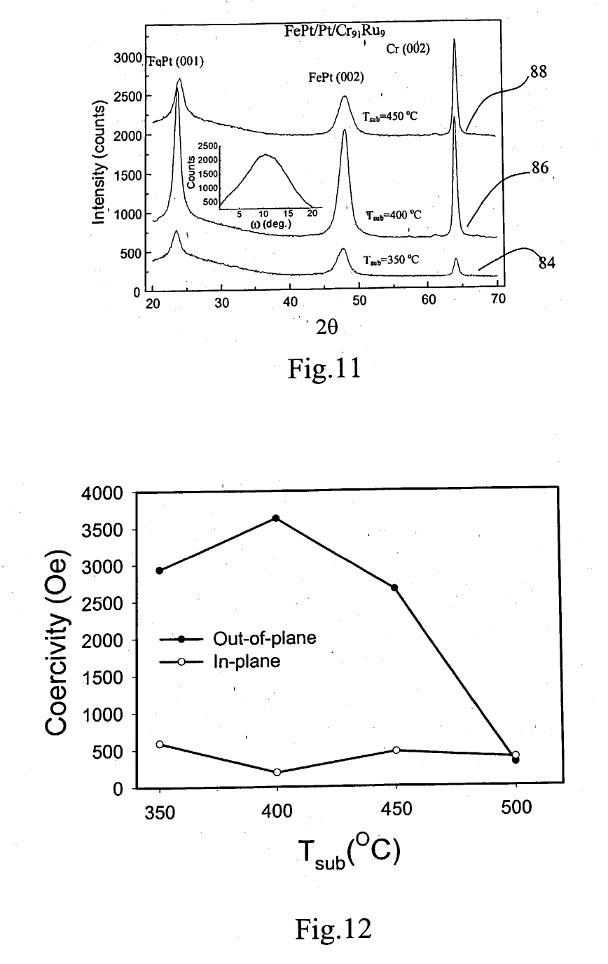

FIG. 11 shows θ-2θ X-ray diffraction (XRD) scan spectra: 84, 86, and 88 of Cr₉₁Ru₉ (80 nm)/Pt/FePt (20 nm) films deposited at different substrate temperatures. The thickness of the Pt intermediate layer is set at t_{Pt}=4 nm. The FePt-fct (001) peak was formed at T_{sub}=350° C. and the highest FePt-fct (001) peak intensity was formed at T_{sub}=400° C. The inset of FIG. 11 is a rocking curve of the FePt-fct (001) peak. The Full Width at Half Maximum Height (FWHM) of the rocking curve is about 7°, indicating a good FePt-fct (001) texture. Compared to the sample without a Pt intermediate layer deposited at temperature 400° C., the FePt-fct (001) texture is much enhanced. As the substrate temperature further increases the intensity of the FePt-fct (001) peak decreases, which result from the enhancement of Cr diffusion into both the Pt layer and the FePt layer at high temperature.

FIG. 12 shows the variation of the coercivities with substrate temperature for Cr₉₁Ru₉ (80 nm)/Pt (4 nm)/FePt (20 nm) film. As the substrate temperature increases, the out-of-plane coercivity first increases with the substrate temperature, reaching its maximum at 400° C. Further increasing the substrate temperature causes the out-of-plane coercivity to start decreasing. This observation in FIG. 12 is consistent with that of FIG. 11.

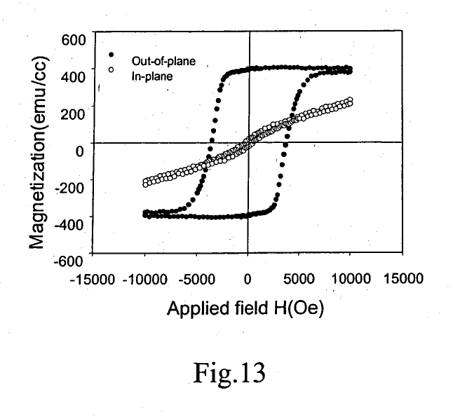

FIG. 13 shows the out-of-plane and in-plane hysteresis loops of Cr₉₁Ru₉ (80 nm)/Pt (4 nm)/FePt (20 nm) deposited at the temperature of 400° C. The out-of-plane loop shows a coercivity of 3.7 kOe with permanent magnetization squareness of 0.97, nucleation field of 2.5 kOe, and a coercivity slope of 4.0. The in-plane coercivity is 190 Oe, which is much smaller than the out-of-plane coercivity. These indicate that good FePt-fct (001) texture with good perpendicular properties has been achieved at a lower deposition temperature.

While the invention has been particularly shown and described with reference to the preferred embodiments, it will be understood by those skilled in the art that various changes in form and detail may be made without departing from the spirit, scope and teaching of the invention. Accordingly, the disclosed invention is to be considered merely as illustrative and limited in scope only as specified in the appended claims, along with the full scope of equivalents to which those claims are legally entitled.

We claim:

1. A method of fabricating a magnetic film on a substrate, comprising:
depositing a chromium alloy underlayer on the substrate, wherein the chromium alloy in the underlayer has a (002) orientation; and
depositing an iron platinum alloy as a magnetic layer by magnetron sputtering, wherein the iron platinum alloy in the magnetic layer is of a face-centered-tetragonal structure with a (001) orientation.

2. The method according to claim 1, wherein the chromium alloy is selected from a group of alloys consisting of CrRu, CrMo, CrMn, CrW, CrTi, CrZr and CrV.

3. The method according to claim 1, wherein the percentage of the chromium in the alloy is 80% to 100%.

4. The method according to claim 1, wherein the percentage of the chromium in the alloy is 90% to 94%.

5. The method according to claim 1, wherein the underlayer has a thickness between 5 nm and 80 nm.

6. The method according to claim 1, wherein the substrate is maintained at a temperature range from about 200° C. to about 400° C. during depositing of the underlayer.

7. The method according to claim 1, further includes depositing an intermediate layer on the underlayer.

8. The method according to claim 7, wherein the intermediate layer has a thickness in the range from about 1 nm to about 4 nm.

9. The method according to claim 7, wherein the intermediate layer has a lattice constant and structure that matches the lattice constant and structure of at least one of a group consisting of the underlayer and the magnetic layer.

10. The method according to claim 7, wherein the intermediate layer has a lattice constant that matches that of at least one of a group consisting of the underlayer and the magnetic layer.

11. The method according to claim 7, wherein the intermediate layer has a structure that matches that of one of at least one of a group consisting of the underlayer and magnetic layer.

12. The method according to claim 10 or 11, wherein the intermediate layer has a face centered cubic structure and is selected from a group consisting of Ag, Au, and Al.

13. The method according to claim 9, wherein the intermediate layer has a B2 structure and is selected from a group consisting of NiAl and FeAl.

14. The method according to claim 9, wherein the intermediate layer has a face-centered-cubic structure and is selected from a group consisting of Pt and Pd.

15. The method according to claim 10, wherein the intermediate layer has a body centered cubic structure and comprises iron.

16. The method according to claim 1, wherein the magnetic layer is formed by magnetron co-sputtering of iron, platinum, and at least one of a group of elements consisting of C, Cr, Zr, Cu, Ta, SiO₂, MgO, Al₂O₃, B₂O₃ and B.

17. The method according to claim 1, wherein depositing of the iron platinum magnetic layer occurs at a temperature below 500° C.

18. The method according to claim 1, wherein the magnetic layer has a thickness in the range between about 5 nm to about 20 nm.

19. The method according to claim 1, wherein the substrate is selected from a group consisting of Ni—P coated AlMg, glass, glass ceramic, and glassy carbon.

20. The method according to claim 1, further comprising pre-coating the substrate with a seed layer to decrease a grain size of the underlayer and the magnetic layer.

21. The method according to claim 20, wherein the seed layer is selected from a group consisting of Ta, NiAl, and C.

22. A magnetic recording medium having a layered structure on a substrate, the layered structure comprising:
a chromium alloy underlayer; and
a magnetic layer;
wherein the magnetic layer is chemically ordered and is (001) textured.

23. The magnetic recording medium of claim 22, wherein the chromium alloy is selected from a group of alloys consisting of CrRu, CrMo, CrMn, CrW, CrTi, CrZr, and CrV.

24. The magnetic recording medium of claim 22, wherein the percentage of chromium in the first layer is from about 80% to about 100%.

25. The magnetic recording medium of claim 24, wherein the percentage of chromium in the first layer is from about 90% to about 94%.

26. The magnetic recording medium of claim 22, and further comprising an intermediate layer deposited on the chromium alloy layer.

27. The magnetic recording medium of claim 26, wherein the intermediate layer has a lattice constant that matches that of at least one of a group consisting of the underlayer and the magnetic layer.

28. The magnetic recording medium of claim 26, wherein the intermediate layer has a structure that matches that of one of a group consisting of the underlayer and magnetic layer.

29. The magnetic recording medium of claim 27 or 28, wherein the intermediate layer has a face centered cubic structure and is selected from a group consisting of Ag, Au, and Al.

30. The magnetic recording medium of claim 27, wherein the intermediate layer has a B2 structure and is selected from a group consisting of NiAl and FeAl.

31. The magnetic recording medium of claim 27, wherein the intermediate layer has a face centered cubic structure and is selected from a group consisting of Pt and Pd.

32. The magnetic recording medium of claim 28, wherein the intermediate layer has a face centered cubic structure and comprises iron.

33. The magnetic recording medium of claim 26, wherein the intermediate layer has a thickness in the range from about 1 nm to about 4 nm.

34. The magnetic recording medium of claim 22, wherein the magnetic layer is formed by magnetron co-sputtering of iron, platinum, and at least one of a group of elements consisting of C, Cr, Zr, Cu, Ta, SiO₂, MgO, Al₂O₃, B₂O₃, and B.

35. The magnetic recording medium of claim 22, wherein the magnetic layer has a thickness ranging from about 5 nm to about 20 nm.

36. The magnetic recording medium of claim 22, wherein the substrate is selected from a group consisting of Ni—P coated AlMg, glass, glass ceramic, and glassy carbon.

37. The magnetic recording medium of claim 22, wherein the substrate is pre-coated with a seed layer to decrease the grain size of the underlayer and the magnetic layer.

38. The magnetic recording medium of claim 37, wherein the seed layer is selected from a group consisting of Ta, NiAl, and C.
